(19) United States
(12) Patent Application Publication
(10) Pub. No.: US 2016/0109091 A1
(43) Pub. Date: Apr. 21, 2016

(54) BACKLIGHT ASSEMBLY

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); LI JIANG, Shenzhen (CN); DONG-HAI LI, Shenzhen (CN)

(21) Appl. No.: 14/573,964

(22) Filed: Dec. 17, 2014

(30) Foreign Application Priority Data
Oct. 15, 2014 (CN) 201410543647.9

(51) Int. Cl. F21V 5/00; F21V 23/00; F21V 29/74

(52) U.S. Cl. CPC F21V 5/008; F21V 29/74; F21V 23/005; F21Y 2113/007

(57) ABSTRACT

A backlight assembly includes a base unit, a light source unit, and a backlight unit. The base unit includes a case defining a cavity, and the cavity includes a first receiving space and a second receiving space communicating with the first receiving space. The light source unit is received in the second receiving portion and configured for emitting light. The backlight assembly includes a first lens module and a second lens module; the first lens module is received in the first receiving space and configured for reflecting the light from the light source unit, the second lens module is mounted to the case and configured for receiving the light from the first lens module and emitting out.

### FIELD

The subject matter herein generally relates to a backlight assembly, and particularly relates to a backlight assembly for image capturing.

### BACKGROUND

Light source is important for image capturing, brightness, parallelism, and chroma of the light source may affect a definition of images. When the backlight is used to capture image from a back of a workpiece, an outline image of the workpiece is captured. However, backlight is normally a monochromatic light, which has a poor parallelism. When the workpiece is with colors, the colors may interfere the monochromatic light, therefore, the quality of image may be affected.

### BRIEF DESCRIPTION OF THE DRAWINGS

Implementations of the present technology will now be described, by way of example only, with reference to the attached figures.

FIG. 1 is an isometric view of an exemplary embodiment of a backlight assembly.

FIG. 2 is an exploded view of the backlight assembly of FIG. 1.

FIG. 3 is another exploded view of the backlight assembly of FIG. 1.

FIG. 4 is a cross-sectional view of the backlight assembly taken along line IV-IV of FIG. 1.

FIG. 5 is a diagram of light paths of the backlight assembly of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

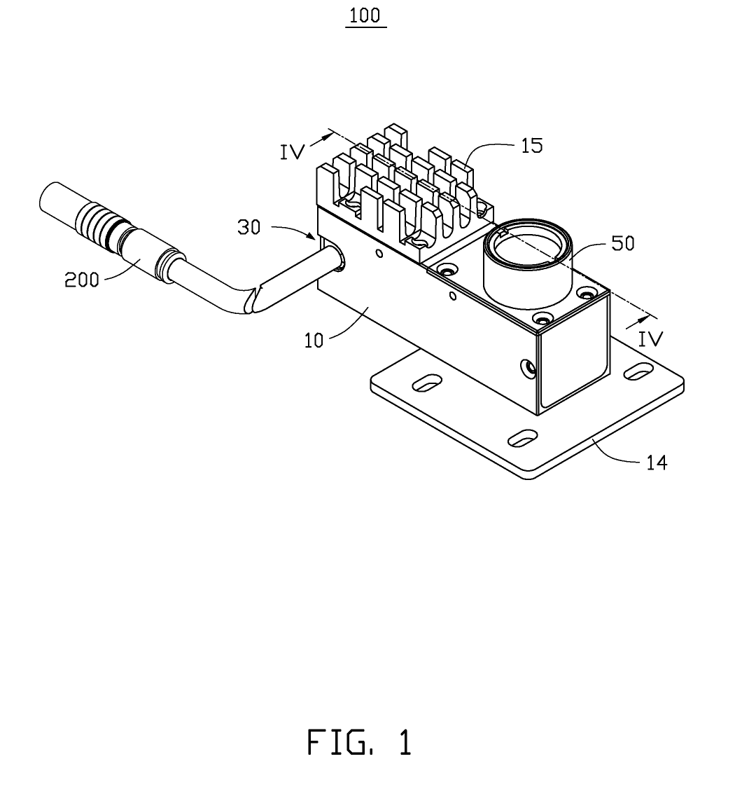

FIG. 1 illustrates an exemplary embodiment of a backlight assembly 100 coupling to a control unit (not shown) via a connecting cable 200. The control unit is configured for actuating the backlight assembly 100 and controlling colors of lights that the backlight assembly 100 emits. The backlight assembly 100 includes a base unit 10, a light source unit 30, and a backlight unit 50. The light source unit 30 and the backlight unit 50 are mounted on the base unit 10.

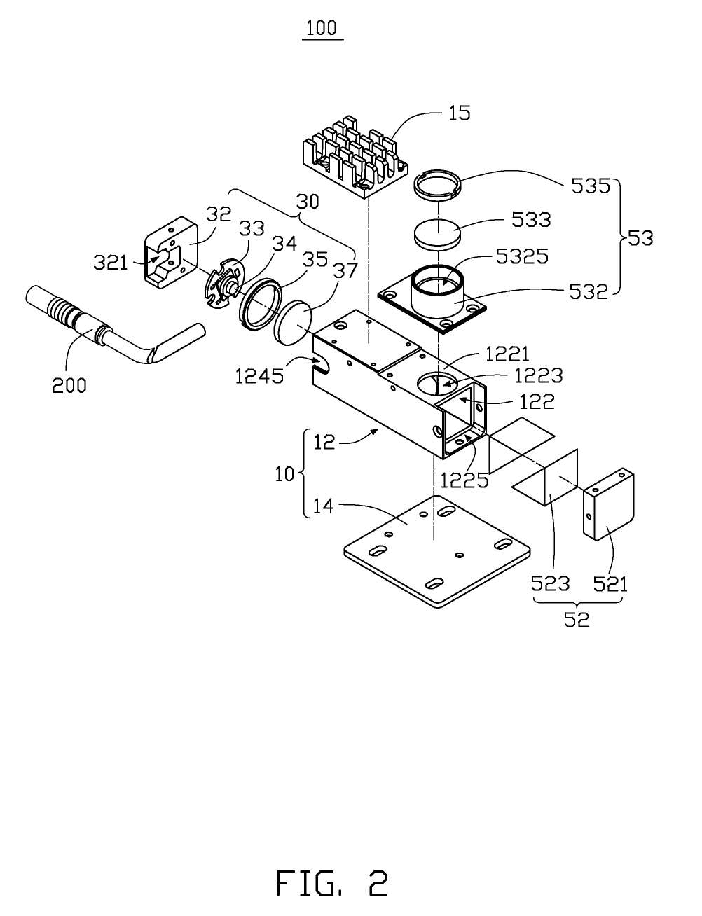

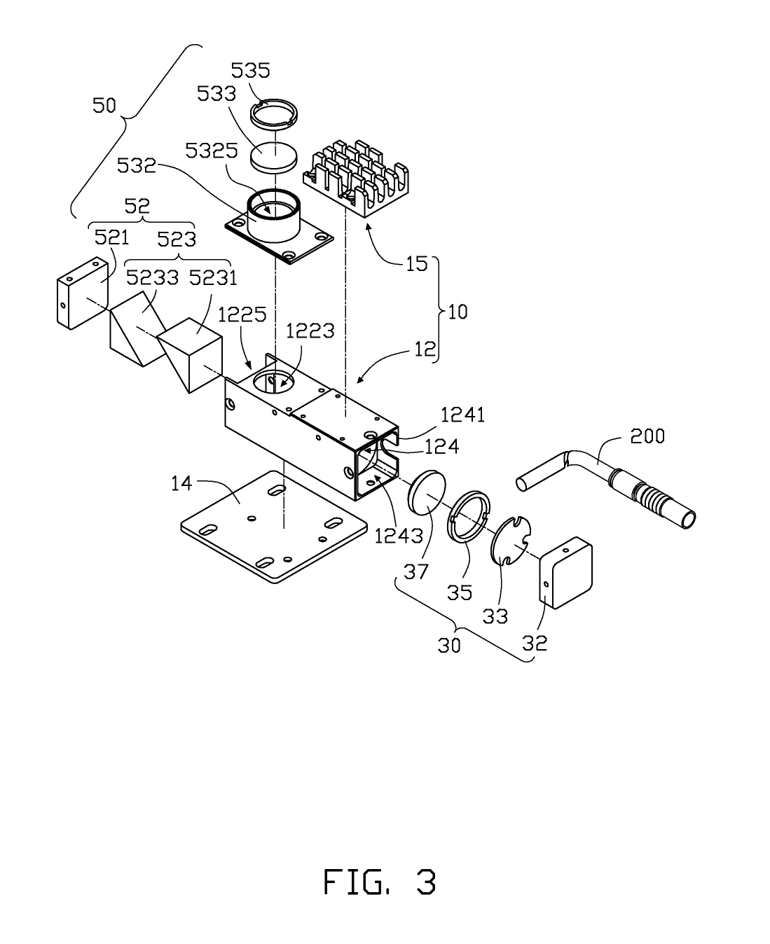

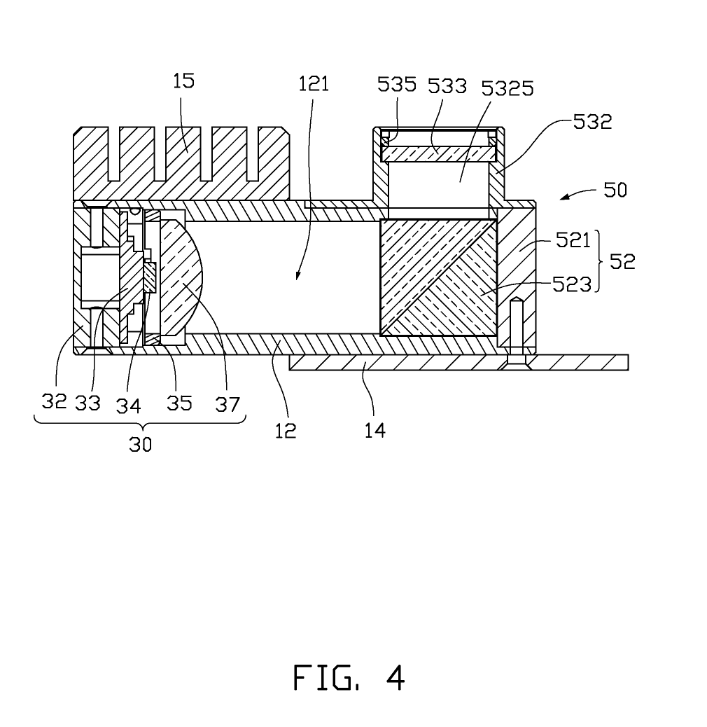

FIGS. 2 and 3 illustrate exploded views of the backlight assembly 100. The base unit 10 includes a case 12, a bottom board 14, and a cooling fin 15. The case 12 is rectangular in shape and defines a cavity 121 (labeled in FIG. 4) therethrough. The cavity 121 includes a first receiving space 122 on one end and a second receiving space 124 on the other end. In one embodiment, the first receiving space 122 is square in shape and is for receiving the backlight unit 50. The second receiving space 124 is circular in shape and is for receiving the light source unit 30.

The first receiving space 122 includes four side walls 1221; one of the side walls 1221 defines a mounting hole 1223 communicating with the first receiving space 122. The other three side walls 1221 extend outwardly from the first receiving space 122, thereby forming a receiving groove 1225 communicating with the first receiving space 122. The second receiving space 124 includes four peripheral walls 1241; the four peripheral walls 1241 extend outwardly from the second receiving space 124, thereby forming a latching groove 1243 communicating with the second receiving space 124. One of the peripheral walls 1241 defines an opening 1245 for receiving the connecting cable 200. The bottom board 14 fixes the backlight assembly 100 to a platform (not shown). The cooling fin 15 is mounted on the case 12 and adjacent to the second receiving space 124. The cooling fin 15 is configured for dissipating heat from the light source unit 30.

The light source unit 30 is configured for providing light source for the backlight assembly 100. One end of the light source unit 30 is received in the second receiving space 124, the other end is received in the latching groove 1243. The light source unit 30 includes a pedestal 32, a circuit board 33, a LED light source 34, a fixing ring 35, and a condensation lens 37. The pedestal 32 is mounted in the latching groove 1243 and covers the latching groove 1243. The pedestal 32 defines an engaging slot 321 and holds the circuit board 33. When the pedestal 32 is mounted to the latching groove 1243, the opening 1245 communicates with the engaging slot 321. The connecting cable 200 can be inserted through the opening 1245 and received in the engaging slot 321 and further electrically connected to the circuit board 33. One side of the circuit board 33 is coupled to the engaging slot 321, the other side arranges at least one LED light source 34. The circuit board 33 is configured for controlling colors of the light that the LED light source 34 emits, thereby the LED light source 34 can emit light with multiple colors. The fixing ring 35 is fixed in the second receiving space 124 and receives the LED light source 34. One side of the fixing ring 35 resists the circuit board 33; the other side resists the condensation lens 37. The LED light source 34 emits lights to the condensation lens 37. The condensation lens 37 gathers the lights from the LED light source 34 and illuminates on the backlight unit 50.

The backlight unit 50 is configured for processing the lights emitted by the light source unit 30 and emitting out. The backlight unit 50 includes a first lens module 52 and a second lens module 53. The first lens module 52 is mounted in the first receiving space 122, the second lens module 53 is mounted to the case 12 and adjacent to the first lens module 52. The first lens module 52 is configured for converting the lights from the light source 30 to parallel lights. The first lens module 52 includes a cover board 521 and two reflection lenses 523. The cover board 521 is mounted in the receiving groove 1225 and covers the receiving groove 1225. The two reflection lenses 523 are coupled to the cover board 521. In one embodiment, each reflection lens 523 includes two incident surfaces 5231 and an incline surface 5233. The two reflection lenses 523 engage together to form a cube by coupling the incline surface 5233 of each reflection lens 523 together. One of the two incident surfaces 5231 of one reflection lens 523 is coupled to the cover board 521.

The second lens module 53 is configured for emitting the lights that converted by the first lens module 52 to the workpiece (not shown). The second lens module 53 includes a lens holder 532, a transparent piece 533, and a connecting ring 535. The lens holder 532 defines a transparent hole 5325. The lens holder 532 is mounted to the case 12 and the transparent hole 5325 is aligned to the mounting hole 1223. The connecting ring 535 latches the transparent piece 533 into the transparent hole 5325, thereby the transparent piece 533 is aligned with the mounting hole 1223.

FIG. 4 illustrates a cross-sectional view of the backlight assembly 100. Assembling the backlight assembly 100 can be operated as follows: the light source unit 30 is received in the second receiving space 124, the pedestal 32 latches to the latching groove 1243, a centre of the LED light source 34 and the condensation lens 37 are on a central axes of the cavity 121. The backlight unit 50 is mounted to the case 12, and the first lens module 52 is received in the first receiving space 122. The incline surfaces 5233 of the two reflection lens 523 engage together; one incident surface 5231 of one reflection lens 523 is aligned to the mounting hole 1223, while another incident surface 5231 is aligned to the condensation lens 37. The second lens module 53 is mounted to the case 12 and aligned to the mounting hole 1223. The transparent hole 5325 is aligned to the mounting hole 1223, thereby the light reflected by the reflection lens 523 can reach the transparent piece 533 receiving in the transparent hole 5325.

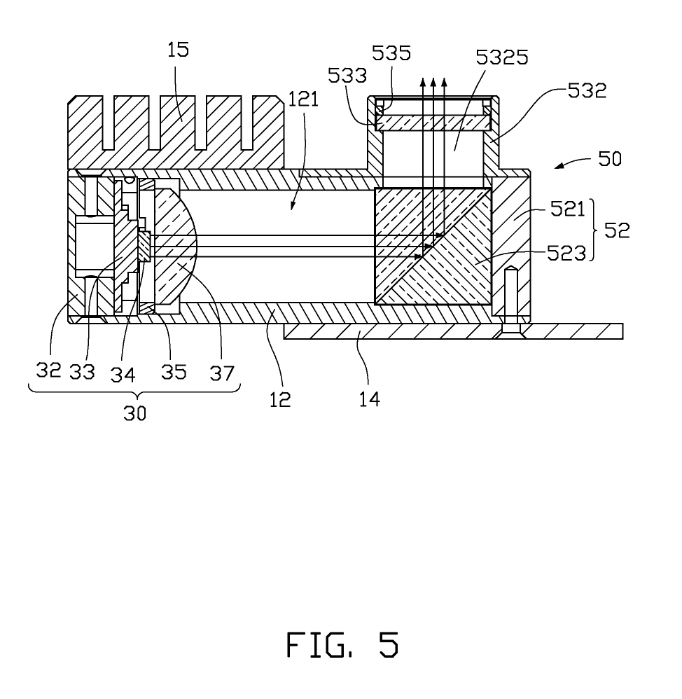

FIG. 5 illustrates that light paths of the backlight assembly 100. When the backlight assembly 100 operates, the light source unit 30 can be actuated via the control unit (not shown). The LED light source 34 emits light to the condensation lens 37, and the condensation lens 37 strengthens the light and emits to the two reflection lens 523 via the cavity 121. The two reflection lenses 523 reflect and adjust the light parallel in one direction via the incident surfaces 5231 and the incline surfaces 5233. The transparent piece 533 passes through the parallel light in one direction from the reflection lens 523 and emit out of the backlight assembly 100.

The backlight assembly 100 includes the light source unit 30 and the backlight unit 50, and the light source unit 30 includes the LED light source 34 emitting light with multiple colors. The backlight unit 50 adjusts the light to parallel in one direction for capturing images, thereby increasing quality of the images.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A backlight assembly comprising:
a base unit comprising a case defining a cavity, the cavity comprising a first receiving space and a second receiving space communicating with the first receiving space;
a light source unit received in the second receiving space and configured for emitting light; and
a backlight unit comprising a first lens module and a second lens module, the first lens module received in the first receiving space and configured for reflecting the light from the light source unit, the second lens module mounted to the case and configured for receiving the light from the first lens module and emitting the light out from the backlight assembly.

2. The backlight assembly as claimed in claim 1, wherein the first receiving space comprises four side walls; one of the side walls defines a mounting hole communicating with the first receiving space; the other three side walls extend outwardly from the first receiving space, thereby forming a receiving groove communicating with the first receiving space.

3. The backlight assembly as claimed in claim 2, wherein the first lens module comprises a cover board and two reflection lenses; the cover board is mounted in the receiving groove and covers the receiving groove; each of the two reflection lenses includes two incident surfaces and an incline surface; the two reflection lenses engage together to form a cube by coupling the incline surface of each reflection lens together.

4. The backlight assembly as claimed in claim 3, wherein the second lens module comprises a lens holder, a transparent piece, and a connecting ring; the lens holder defines a transparent hole; the lens holder is mounted to the case and the transparent hole is aligned to the mounting hole; the connecting ring latches the transparent piece into the transparent hole, thereby the transparent piece is aligned with the mounting hole.

5. The backlight assembly as claimed in claim 4, wherein one of the two incident surfaces of one of the reflection lenses is coupled to the cover board; one of the two incident surfaces of the other reflection lens is aligned to the mounting hole and thereby aligned to the transparent hole and the transparent piece; while the other incident surface faces the cavity and the light source unit.

6. The backlight assembly as claimed in claim 1, wherein the second receiving space comprises four peripheral walls; the four peripheral walls extend outwardly from the second receiving space, thereby forming a latching groove communicating with the second receiving space.

7. The backlight assembly as claimed in claim 6, wherein the light source unit includes a pedestal, a circuit board, at least one LED light source, and a condensation lens; the pedestal is mounted in the latching groove and covers the latching groove; the circuit board is fixed in the second receiving space, one side of the circuit board is coupled to the pedestal; the at least one LED light source is arranged on other side of the circuit board and faces the condensation lens.

8. The backlight assembly as claimed in claim 7, wherein the LED light source emits light to the condensation lens, the condensation lens gathers the light from the LED light source and illuminates on the backlight unit; the circuit board is configured for controlling colors of the light that the LED light source emits, thereby the LED light source emits light with multiple colors.

9. The backlight assembly as claimed in claim 7, further comprising a connecting cable, wherein one of the peripheral walls defines an opening for receiving the connecting cable, the pedestal defines an engaging slot, the opening communicates with the engaging slot, the connecting cable is inserted through the opening and received in the engaging slot and further electrically connected to the circuit board.

10. The backlight assembly as claimed in claim 1, wherein the base unit further comprises a cooling fin, the cooling fin is mounted on the case and adjacent to the second receiving space for dissipating heat from the light source unit.

11. A backlight assembly comprising:
a base unit comprising a case defining a cavity, the cavity comprising a first receiving space and a second receiving space communicating with the first receiving space;
a light source unit received in the second receiving space; and
a backlight unit comprising a first lens module and a second lens module, the first lens module received in the first receiving space, the second lens module mounted to the case;
wherein the light source unit is configured for emitting light with different colors to the first lens module, the first lens module is configured for adjusting and reflecting the light to the second lens module, the second lens module is configured for emitting the light out of the backlight assembly.

12. The backlight assembly as claimed in claim 11, wherein the first receiving space comprises four side walls; one of the side walls defines a mounting hole communicating with the first receiving space; the other three side walls extend outwardly from the first receiving space, thereby forming a receiving groove communicating with the first receiving space.

13. The backlight assembly as claimed in claim 12, wherein the first lens module comprises a cover board and two reflection lenses; the cover board is mounted in the receiving groove and covers the receiving groove; each of the two reflection lenses includes two incident surfaces and an incline surface; the two reflection lenses engage together to form a cube by coupling the incline surface of each reflection lens together.

14. The backlight assembly as claimed in claim 13, wherein the second lens module comprises a lens holder, a transparent piece, and a connecting ring; the lens holder defines a transparent hole; the lens holder is mounted to the case and the transparent hole is aligned to the mounting hole; the connecting ring latches the transparent piece into the transparent hole, thereby the transparent piece is aligned with the mounting hole.

15. The backlight assembly as claimed in claim 14, wherein the one of the two incident surfaces of one of the reflection lenses is coupled to the cover board; one of the two incident surfaces of the other reflection lens is aligned to the mounting hole and thereby aligned to the transparent hole and the transparent piece; while the other incident surface faces the cavity and the light source unit.

16. The backlight assembly as claimed in claim 11, wherein the second receiving space comprises four peripheral walls; the four peripheral walls extend outwardly from the second receiving space, thereby forming a latching groove communicating with the second receiving space.

17. The backlight assembly as claimed in claim 16, wherein the light source unit includes a pedestal, a circuit board, at least one LED light source, and a condensation lens; the pedestal is mounted in the latching groove and covers the latching groove; the circuit board is fixed in the second receiving space, one side of the circuit board is coupled to the pedestal; the at least one LED light source is arranged on other side of the circuit board and faces the condensation lens.

18. The backlight assembly as claimed in claim 17, wherein the LED light source emits light to the condensation lens, the condensation lens gathers the light from the LED light source and illuminates on the backlight unit; the circuit board is configured for controlling colors of the light that the LED light source emits, thereby the LED light source emits light with multiple colors.

19. The backlight assembly as claimed in claim 17, further comprising a connecting cable, wherein one of the peripheral walls defines an opening for receiving the connecting cable, the pedestal defines an engaging slot, the opening communicates with the engaging slot, the connecting cable is inserted through the opening and received in the engaging slot and further electrically connected to the circuit board.

20. The backlight assembly as claimed in claim 11, wherein the base unit further comprises a cooling fin, the cooling fin is mounted on the case and adjacent to the second receiving space for dissipating heat from the light source unit.
